(19) United States
(12) Patent Application Publication
(10) Pub. No.: US 2024/0158983 A1
(43) Pub. Date: May 16, 2024

(54) METHOD FOR TREATING FABRICS

(71) Applicant: SPECIALTY OPERATIONS FRANCE, Lyon (FR)

(72) Inventors: Sujandi Zhou, Singapore (SG); Galder Cristobal, Singapore (SG)

(73) Assignee: SPECIALTY OPERATIONS FRANCE, Lyon (FR)

(21) Appl. No.: 18/550,271

(22) PCT Filed: Mar. 12, 2021
(86) PCT No.: PCT/EP2021/056343

§ 371 Date: Sep. 12, 2023

(51) Int. Cl. D06M 15/03; C11D 1/83; C11D 1/94; C11D 3/22

(52) U.S. Cl. CPC D06M 15/03; C11D 1/83; C11D 1/94; C11D 3/222; C11D 2111/12; D06M 2200/00

(57) ABSTRACT

The invention relates to a method for treating a fabric, notably a method for preventing or recovering degradation of a fabric, by using a natural polygalactomannan.

### FIELD OF THE INVENTION

The present invention relates to a method for treating a fabric, notably a method for preventing or recovering degradation of a fabric, by using an unmodified natural polygalactomannan in which the unmodified natural polygalactomannan has a specific viscosity.

### BACKGROUND

Washing of fabrics, especially machine washing of fabrics, leads to a physical and chemical degradation of the fabric fibers, and most particularly of cotton and wool fibers. The alkalinity delivered by detergents and also by certain specific compounds, such as oxidizing substances (perborate or percarbonate) and certain enzymes, may be the cause of the chemical degradation of fabric fibers. However, it is generally the combination of the chemical and mechanical actions which leads to degradation of the fibers. The mechanical action is produced during the washing, rinsing, spin-drying or tumble-drying, when the latter takes place in a tumble dryer. This degradation of the fibers leads to the formation of fibrils at surface of the fabrics, and this may also cause colored fabrics to lose their radiance. This degradation also induces a decrease in the strength of the fabrics which, at the extreme, may lead to tearing. Cleaning in a washing machine, which normally includes a spin-drying operation, also leads to creased fabrics, which is accentuated during the tumble-drying stage, in particular by the formation of inter-fiber hydrogen bonds. It is thus necessary to iron the fabrics in order to make them look presentable.

There is a need to provide a method for treating fabrics which causes minimal degradation of the fabrics. There is a need to provide a composition for treating fabrics, such as for washing fabrics, which causes minimal degradation of the fabrics. There is a need to provide an agent for preventing or recovering degradation of the fabrics.

US patent publication no. 2004/0067864 discloses use of an amphoteric polysaccharide in compositions for caring fabrics. The composition can prevent degradation of fabrics and protect the colors of fabrics.

WO 2020/099463 discloses the use of cationic polygalactomannan containing non-ionic hydroxyalkyl substituents, which can used for preventing or recovering degradation of a fabric. However, the cationic polygalactomannan is chemically modified and is not an unmodified natural polygalactomannan. Accordingly, there remains a need for natural polygalactomannans for treating fabrics, and more specifically, there remains a need for natural polygalactomannans for preventing or recovering degradation of a fabric.

### SUMMARY OF THE INVENTION

The aim of the present invention is therefore to provide an ingredient which is useful for preventing or recovering degradation of fabrics during treatment of fabrics.

It is also an object of the present invention to provide an ingredient which is additionally effective in recovering fabrics which already have degradation.

It is also an object of the present invention to provide an ingredient which is additionally effective in protecting the colors of fabrics.

It is also an object of the present invention to provide a composition for treating fabrics which would cause minimal degradation of the fabrics.

It has now been unexpectedly discovered that a specific polygalactomannan having a specific viscosity is useful as an agent for preventing or reducing degradation of fabrics. In particular, the specific polygalactomannan is a natural polygalactomannan, and more specifically, the polygalactomannan is a chemically unmodified natural polygalactomannan. The natural polygalactomannan can recover fibrils at surface of the fabric fibers, and thus, can protect the strength of the fabrics. The natural polygalactomannan can also protect against color fading or color changing of the fabrics. More specifically, as fabric degradation occurs, either by chemical or physical degradation, this can lead to fading of the fabric color such that the color is less vibrant, or changing of the fabric color, including yellowing and greying of the fabric color. The natural polygalactomannan can be advantageously included in compositions used for treating fabrics, such as detergent compositions.

The subject of the invention is thus a method for treating a fabric, notably a method for preventing or recovering degradation of a fabric, comprising the step of contacting the fabric with a natural polygalactomannan, wherein said natural polygalactomannan has a viscosity of 1,000 to 10,000 mPa·s, as measured on a Brookfield RVT viscosimeter at 25° C. and 20 rpm, at a concentration of 1 wt. % in water. The fabric may be contacted with the natural polygalactomannan during a treatment of the fabric, such as washing or conditioning of the fabric.

By using the specific natural polygalactomannans having a specific viscosity according to the invention, fabric fiber surface may advantageously look smoother, and fibrils may be recovered and/or prevented. These benefits can for instance be demonstrated through microscopy or high magnification photograph, as shown in the Examples.

Advantageously, no residual powder arises from the use of the specific natural polygalactomannans having the specific viscosity according to the invention.

Advantageously, the specific natural polygalactomannan having the specific viscosity according to the invention may also provide durable color protection, meaning in particular that colored fabrics may resist multiple washing cycles.

According to another specific aspect, the present invention is directed to the use of the natural polygalactomannan as defined herein for color protection of fabrics.

The present invention is also directed to a method for protecting the colors of fabrics, for example during a treatment of the fabrics, comprising the step of contacting the fabrics with a natural polygalactomannan having a viscosity of 1,000 to 10,000 mPa·s, as measured on a Brookfield RVT viscosimeter at 25° C. and 20 rpm with a #3 or #4 spindle, at a concentration of 1 wt % in water.

### FIGURES

FIG. 1a depicts a test fabric under magnification after ten (10) washes without being treated with the Natural Polygalactomannan in Example 1, in which the test fabric was line dried.

FIG. 1b depicts a test fabric under magnification after ten (10) washes being treated with the Natural Polygalactomannan in Example 1, in which the test fabric was line dried.

FIG. 1c depicts the test fabric of FIG. 1a under higher magnification after ten (10) washes without being treated with the Natural Polygalactomannan in Example, in which the test fabric was line dried.

FIG. 1d depicts the test fabric of FIG. 1b under higher magnification after ten (10) washes being treated with the Natural Polygalactomannan in Example 1, in which the test fabric was line dried.

### DETAILED DESCRIPTION

As used herein, the term “fabric” includes woven goods and also nonwoven or felted, porous or perforated goods, and similar goods having flexible or pliable characteristics which are suitable for use in clothing, headgear, footwear, and similar uses, regardless of whether the material of the goods is in one layer or multiple layers and regardless of whether the goods are natural, synthetic, or blended, such as cotton, wool, silk.

As used herein, the term “treating fabric” or “treatment of fabrics” includes and is not limited to: washing and cleaning of fabrics, pretreatment of fabrics, conditioning of fabrics such as delicate fabric washing, and post-treatment such as softening and ironing.

As used herein, the term “degradation of fabrics” refers to any physical or chemical degradation phenomena of fabrics, which may be in form of: formation of fibrils, fading/change of colors, tearing, reduced fabric tensile strength, increased crispness, loss in smoothness.

Polygalactomannans

Polygalactomannans are polysaccharides consisting mainly of the monosaccharides mannose and galactose. The mannose-elements form a chain consisting of many hundreds of (1,4)-β-D-mannopyranosyl-residues, with 1,6 linked-D-galactopyranosyl-residues at varying distances, dependent on the plant of origin. Naturally occurring polygalactomannans are available from numerous sources, including guar gum, guar splits, locust bean gum, flame tree gum and cassia gum.

Guar gum refers to the mucilage found in the seed of the leguminous plant Cyamopsis tetragonolobus. The water soluble fraction (85%) is called “guaran,” which consists of linear chains of (1,4)-β-D mannopyranosyl units-with α-D-galactopyranosyl units attached by (1,6) linkages. The ratio of D-galactose to D-mannose in guaran is about 1:2.

Guar seeds are composed of a pair of tough, non-brittle endosperm sections, hereafter referred to as “guar splits,” between which is sandwiched the brittle embryo (germ). After dehulling, the seeds are split, the germ (43-47% of the seed) is removed by screening, and the splits are ground. The ground splits are reported to contain about 78 to 82 wt. % poly
galactomannan polysaccharide and minor amounts of some proteinaceous material, inorganic non-surfactant salts, water-insoluble gum, and cell membranes, as well as some residual seedcoat and embryo.

Locust bean gum or carob bean gum is the refined endosperm of the seed of the carob tree, Ceratonia siliqua. The ratio of galactose to mannose for this type of gum is about 1:4. Locust bean gum is commercially available.

As mentioned previously, the polygalactomannans used in the invention are natural polygalactomannans (i.e., naturally occurring polygalactomannans). That is to say, the polygalactomannans useful for the invention are polygalactomannans that are unmodified natural polygalactomannans. As used herein, “natural polygalactomannans”, including “unmodified natural polygalactomannans”, means polygalactomannans that have not been modified to include different, additional, or less chemical substituent groups on the polysaccharide backbone or polysaccharide side groups. Rather, in certain embodiments, the natural polygalactomannans generally have the same polysaccharide backbone and polysaccharide side groups as the polygalactomannans extracted from the source. The natural polygalactomannans that can be used in the invention are in contrast to chemically modified polygalactomannans, such as polygalactomannans having cationic, nonionic or anionic substituent groups or the mixture of thereof at one or more sites of the polygalactomannan. Such chemically modified polygalactomannans having cationic substituent groups are generally known as cationic polygalactomannans, chemically modified polygalactomannans having nonionic substituent groups are generally known as nonionic polygalactomannans, chemically modified polygalactomannans having anionic substituent groups are generally known as anionic polygalactomannans, or the mixture thereof.

According to any one of the invention embodiments, the natural polygalactomannan is preferably a guar. In specific preferred embodiments, the natural polygalactomannan is natural guar, which is also known as and can be referred to herein as guar gum, native guar, and guaran,

Processes for extracting natural polygalactomannans from sources are known. For example, as discussed above, natural guar can be extracted from guar seeds, husks, and germs by mechanical processing.

In certain embodiments, the natural polygalactomannan is a depolymerized polygalactomannan, which has been depolymerized by using various techniques, including chemicals such as hydrogen peroxide or cellulase enzymes. In certain preferred embodiments, the natural polygalactomannan is depolymerized natural guar, which is also known as and can be referred to herein as depolymerized guar gum, depolymerized native guar, and depolymerized guaran.

The weight average molecular weight of the polygalactomannan used in the invention may be measured for instance by SEC-MALS or by using gel permeation chromatography.

According to any one of the invention embodiments, the natural polygalactomannan used in the invention can have a weight average molecular weight comprised between about 1,000,000 g/mol and about 10,000,000 g/mol, preferably between 1,000,000 g/mol and 8,000,000 g/mol. In particular embodiments, the natural polygalactomannan can have a weight average molecular weight comprised between 2,000,000 g/mol and 4,000,000 g/mol. In certain preferred embodiments, the natural polygalactomannan can be natural guar (i.e., also known as guar gum, native guar, and guaran), and can have a weight average molecular weight comprised between 1,000,000 and 10,000,000 g/mol, preferably between 1,000,000 and 8,000,000 g/mol. In particular embodiments, the natural polygalactomannan can be natural guar and can have a weight average molecular weight comprised between 2,000,000 g/mol and 4,000,000 g/mol.

Various natural polygalactomannans can be used in the instant invention, including but not limited to natural guars sold under the names Jaguar® S and Jaguar® NAT by Rhodia Operations, which is part of Solvay SA, as well as non-modified nonionic guars including the products sold under the name Vidogum® GH 175 by the company Unipectine, Activesoft® S by the company Innospec Performance Chemicals, AEC Guar Gum by the company A&E Connock (Perfumery & Cosmetic), OriStar Guar Gum by the company Orient Stars LLC, Polycos N-75 (Guar Gum) by the company Polygal AG, Supercol™ U2 by the company Ashland, Meyprodor® 400 by the company Dupont, IGGuar FG by the company India Glycols Limited.

Other potential natural polygalactomannans include, but are not limited to, other natural polysaccharide polymers including, for example, chitosan, pectin, alginate, hyaluronic acid, agar, xanthan, dextrin, starch, cellulose, amylose, amylopectin, alternan, gellan, levan, mutan, dextran, pullulan, fructan, gum arabic, carrageenan, glycogen, glycosaminoglycans, murein, xyloglucans (such as tamarind gum) and bacterial capsular polysaccharides.

Viscosity

It has been unexpectedly found that natural polygalactomannans, including natural guars, with proteinaceous material from 0 to 5% wt. %, with moisture content less than 10% wt. %, having a specific viscosity make it possible to prevent or reduce degradation of fabrics.

The viscosity of the natural polygalactomannan is determined by using a water solution containing 1 wt. % of the natural polygalactomannan, with moisture content less than 10% wt. %, and is measured in mPa·s using a Brookfield RVT viscosimeter using spindle #3 (for a viscosity range of 1,000 to 3,000 mPa·s) or spindle #4 (for a viscosity range of 3,000 to 10,000 mPa·s) at 20 rpm and 25° C.

Further, in specific embodiments in which the natural polygalactomannan is natural guar, the viscosity of the natural guar is determined by using a water solution containing 1 wt. % of the natural guar, and is measured in mPa·s using a Brookfield RVT viscosimeter using spindle #3 or spindle #4 at 20 rpm and 25° C.

The viscosity measurement may be performed for instance according to the following procedure:
weigh out 396 g of demineralised ultrapure water in a 600 ml beaker;
weigh out 4 g of natural polygalactomannan, preferably natural guar, and add it into the 600 ml beaker containing demineralised ultrapure water, under stirring at 200 RPM;
keep stirring until a stable pH value is achieved and adjust pH to 5+/−0.1 with acetic acid;
measure viscosity of the resulting solution using a Brookfield RVT viscosimeter using spindle #3 or spindle #4 at 20 rpm, after equilibration at 25° C. for 1 hour.

According to any one of the invention embodiments, the natural polygalactomannan can have a viscosity of 1,000 to 10,000 mPa·s, more preferably the natural polygalactomannan can have a viscosity of 2,000 to 9,000 mPa·s, and even more preferably the natural polygalactomannan can have a viscosity of 3,000 to 8,000 mPa·s, using a Brookfield RVT viscosimeter at 25° C. and 20 rpm with a spindle #3 or spindle #4, in which 1 wt. % of the natural polygalactomannan is in a water solution. In specific embodiments in which the natural polygalactomannan is natural guar, the natural guar can have a viscosity of 1,000 to 10,000 mPa·s, more preferably the natural guar can have a viscosity of 2,000 to 9,000 mPa·s, and even more preferably the natural guar can have a viscosity of 3,000 to 8,000 mPa·s, using a Brookfield RVT viscosimeter at 25° C. and 20 rpm with a spindle #3 or spindle #4, in which 1 wt. % of the natural guar is in a water solution

In another aspect, the present invention also relates to methods or uses for preventing or recovering degradation of fabrics comprising the step of contacting the fabrics with a composition, notably an aqueous solution, comprising at least one natural polygalactomannan, preferably at least one natural guar, and having a specific viscosity as defined previously.

In another aspect, the present invention also relates to methods or uses for preventing or recovering degradation of fabrics, comprising the step of contacting the fabrics having degradation with a composition, notably an aqueous solution, comprising at least one natural polygalactomannan, preferably at least one natural guar, and having a specific viscosity as defined previously.

In another aspect, the present invention also relates to methods or uses for protecting colors of fabrics, comprising the step of contacting the fabrics with a composition comprising at least one natural polygalactomannan, preferably at least one natural guar, and having a specific viscosity as defined previously.

The natural polygalactomannan according to the invention, and preferably at least one natural guar, may be provided in a concentrated liquid composition, notably a concentrated liquid detergent composition. Such concentrated composition may be diluted and brought into contact with the fabrics.

The concentrated composition preferably contains from 0.01 to 5 wt. % of a natural polygalactomannan, preferably at least one natural guar, and having a specific viscosity according to the invention, relative to the total weight of the composition, for instance from 0.05 to 3 wt. %, for instance from 0.1 to 1 wt. %.

The expression “detergent composition” is used to mean a composition comprising at least a substance or material intended to assist cleaning or having cleaning properties.

According to each one of the invention embodiments, the composition preferably has a pH value of from 6 to 9, such as from 7 to 9.

In one embodiment, the composition, notably the detergent composition, comprises, as the sole agent for preventing or recovering the degradation of fabrics, a natural polygalactomannan, preferably at least one natural guar, and having a specific viscosity as defined previously, and contains no other ingredients for that purpose.

Advantageously the natural polygalactomannan, preferably at least one natural guar, and having a specific viscosity according to the invention may be combined with a wide range of other fabric benefit agents, including but not limited to:

### Anionic Surfactants

Non-limiting examples of anionic surfactants include sulfates and sulfonates, in particular, linear alkylbenzenesulfonat.es (LAS), isomers of LAS, branched alkylbenzenesulfonat.es (BABS), phenylalkanesulfonat.es, alpha-olefinsulfonates (AOS), olefin sulfonates, alkene sulfonates, alkane-2,3-diylbis(sulfates), hydroxyalkanesulfonat.es and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof.

The anionic surfactant may include alkyl ether sulphates, soaps, fatty acid ester sulphonates, alkylamide sulfates, alkyl benzene sulphonates, sulphosuccinate esters, primary alkyl sulphates, olefin sulphonates, paraffin sulphonates and organic phosphate. Preferred anionic surfactants are the alkali and alkaline earth metal salts of fatty acid carboxylates, fatty alcohol sulphates, preferably primary alkyl sulfates, more preferably they are ethoxylated, for example alkyl ether sulphates; alkylbenzene sulphonates, alkyl ester fatty acid sulphonates, especially methyl ester fatty acid sulphonates and mixtures thereof.

Notably, the anionic surfactants may be:
alkyl ester sulfonates of formula R—CH(SO₃M)—COOR′, in which R represents a C₈-C₂₀ and preferably C₁₀-C₁₆ alkyl radical, R′ represents a C₁-C₆ and preferably C₁-C₃ alkyl radical and M represents an alkali metal (sodium, potassium or lithium) cation, a substituted or unsubstituted ammonium (methyl-, dimethyl-, trimethyl- or tetramethylammonium, dimethylpiperidinium, etc.) or an alkanolamine derivative (monoethanolamine, diethanolamine, triethanolamine, etc.). Mention may be made most particularly of methyl ester sulfonates in which the radical R is C₁₄-C₁₆;
alkyl sulfates of formula ROSO₃M, in which R represents a C₅-C₂₄ and preferably C₁₀-C₁₈ alkyl or hydroxyalkyl radical, M representing a hydrogen atom or a cation of the same definition as above, and also the ethoxylenated (EO) and/or propoxylenated (PO) derivatives thereof, containing on average from 0.5 to 30 and preferably from 0.5 to 10 EO and/or PO units;
alkylamide sulfates of formula RCONHR′OSO₃M in which R represents a C₂-C₂₂ and preferably C₆-C₂₀ alkyl radical, R′ represents a C₂-C₃ alkyl radical, M representing a hydrogen atom or a cation of the same definition as above, and also the ethoxylenated (EO) and/or propoxylenated (PO) derivatives thereof, containing on average from 0.5 to 60 EO and/or PO units;
saturated or unsaturated C₈-C₂₄ and preferably C₁₄-C₂₀ fatty acid salts, C₉-C₂₀ alkylbenzenesulfonates, primary or secondary C₈-C₂₂ alkylsulfonates, alkylglyceryl sulfonates, sulfonated polycarboxylic acids, paraffin sulfonates, N-acyl N-alkyltaurates, alkyl phosphates, isethionates, alkyl succinamates, alkyl sulfosuccinates, sulfosuccinate monoesters or diesters, N-acyl sarcosinates, alkylglycoside sulfates, polyethoxycarboxylates; the cation being an alkali metal (sodium, potassium or lithium), a substituted or unsubstituted ammonium residue (methyl-, dimethyl-, trimethyl- or tetramethylammonium, dimethylpiperidinium, etc.) or an alkanolamine derivative (monoethanolamine, diethanolamine, triethanolamine, etc.);

### Nonionic Surfactants

polyoxyalkylenated (polyoxyethylenated, polyoxy-propylenated or polyoxybutylenated) alkylphenols in which the alkyl substituent is C₆-C₁₂ and containing from 5 to 25 oxyalkylene units; examples which may be mentioned are the products Triton X-45, X-114, X-100 or X-102 sold by Rohm & Haas Co.;
glucosamide, glucamide or glycerolamide;
polyoxyalkylenated C₈-C₂₂ aliphatic alcohols containing from 1 to 25 oxyalkylene (oxyethylene or oxypropylene) units; examples which may be mentioned are the products Tergitol 15-S-9 and Tergitol 24-L-6 NMW sold by Union Carbide Corp., Neodol 45-9, Neodol 23-65, Neodol 45-7 and Neodol 45-4 sold by Shell Chemical Co., and Kyro EOB sold by The Procter & Gamble Co.;
products resulting from the condensation of ethylene oxide or the-compound resulting from the condensation of propylene oxide with propylene glycol, such as the Pluronic products sold by BASF;
products resulting from the condensation of ethylene oxide or the compound resulting from the condensation of propylene oxide with ethylenediamine, such as the Tetronic products sold by BASF;
amine oxides such as C₁₀-C₁₈ alkyl dimethylamine oxides and C₈-C₂₂ alkoxy ethyl dihydroxyethylamine oxides;
alkylpolyglycosides;
C₈-C₂₀ fatty acid amides;
ethoxylated fatty acids;
ethoxylated fatty amides;
ethoxylated amines.

### Amphoteric and Zwitterionic Surfactants

betaines or amidobetaines, such as alkyldimethylbetaines, alkylamidopropyldimethylbetaines;
sulfobetaines or amidosulfobetaines, such as alkyltrimethylsulfobetaines, and the products of condensation of fatty acids and of protein hydrolysates;
alkyl amphoacetates or alkyl amphodiacetates in which the alkyl group contains from 6 to 20 carbon atoms.

In one aspect, the present invention relates to a light duty detergent composition or a detergent composition suitable for treating delicate fabrics. Incorporation of the natural polygalactomannan, preferably a natural guar, in such composition renders it causing minimal degradation of fabrics.

Notably, the invention relates to a liquid detergent composition, comprising:
(a) from 0.01 to 5 wt. % of a natural polygalactomannan, preferably at least one natural guar having a viscosity ranging from 1,000 to 10,000 mPa·s, preferably from 2,000 to 9,000 mPa·s, and even more preferably from 3,000 to 8,000 mPa·s, measured by a Brookfield RVT viscosimeter at 25° C. and 20 rpm with a spindle #3 (for viscosity range of 1,000 to 3,000 mPa·s) or spindle #4 (for viscosity range of 3,000 to 10,000 mPa·s), at a concentration of 1 wt. % in water; the amount of the polygalactomannan is for instance from 0.05 to 3 wt. %, for instance from 0.1 to 1 wt. %;
(b) from 0.1 to 20 wt. % of an anionic surfactant; the amount is for instance from 0.5 to 20 wt. %, for instance from 0.5 to 10 wt. %, for instance from 0.5 to 5 wt. %, for instance from 1 to 3 wt. %;
(c) from 0.01 to 20 wt. % of a non-ionic surfactant or an amphoteric surfactant; the amount is for instance from 0.05 to 10 wt. %, for instance from 0.05 to 5 wt. %, for instance from 0.1 to 3 wt. %; and
(d) water;
   weight percentages are based on total weight of the composition.

In a preferred embodiment, the liquid detergent composition comprises:
(a) from 0.01 to 5 wt. % of a natural polygalactomannan preferably at least one natural guar having a viscosity ranging from 1,000 to 10,000 mPa·s, preferably from 2,000 to 9,000 mPa·s, and even more preferably from 3,000 to 8,000 mPa·s, measured by a Brookfield RVT viscosimeter at 25° C. and 20 rpm with a spindle #3 (for viscosity range of 1,000 to 3,000 mPa·s) or spindle #4 (for viscosity range of 3,000 to 10,000 mPa·s), at a concentration of 1 wt. % in water;
(b) from 0.5 to 5 wt. % of an anionic surfactant, for instance from 1 to 3 wt. %;
(c) from 0.05 to 10 wt. % of a non-ionic surfactant or an amphoteric surfactant, for instance from 0.05 to 5 wt. %; and
(d) water;
weight percentages are based on total weight of the composition.

Said anionic surfactant and non-ionic surfactant can be selected from those described above.

The present invention further relates to use of said liquid detergent composition for preventing or recovering degradation of a fabric.

The present invention further relates to use of said liquid detergent composition for protecting colors of a fabric.

According to the invention, detergent adjuvants (“builders”) for improving the surfactant properties may be used in amounts corresponding to about 5-50 wt. % and preferably to about 5-30 wt. % referring to total weight of the liquid composition or to about 10-80 wt. % and preferably 15-50 wt. % for the solid composition, these detergent adjuvants include but are not limited to:

### Mineral Detergent Adjuvants

polyphosphates (tripolyphosphates, pyrophosphates, orthophosphates or hexametaphosphates) of alkali metals, of ammonium or of alkanolamines;
tetraborates or borate precursors;
silicates, in particular those with an SiO₂/Na₂O ratio from about 1.6/1 to 3.2/1;
alkali metal or alkaline-earth metal carbonates (bicarbonates, sesquicarbonates);
cogranulates of alkali metal silicate hydrates and of alkali metal (sodium or potassium) carbonates that are rich in silicon atoms in Q2 or Q3 form;
crystalline or amorphous aluminosilicates of alkali metals (sodium or potassium) or of ammonium, such as zeolites A, P, X, etc.; zeolite A with a particle size of about 0.1-10 micrometers is preferred.

### Organic Detergent Adjuvants

water-soluble polyphosphonates (ethane 1-hydroxy-1,1-diphosphonates-, methylenediphosphonate salts, etc.);
water-soluble salts of carboxylic polymers or copolymers or water-soluble salts thereof, such as:
polycarboxylate ethers (oxydisuccinic acid and its salts, monosuccinic acid tartrate and its salts, disuccinic acid tartrate and its salts);
hydroxypolycarboxylate ethers;
citric acid and its salts, mellitic acid and succinic acid and their salts;
polyacetic acid salts (ethylenediaminetetraacetates, nitrilotriacetates, N-(2-hydroxyethyl)nitrilodiacetates);
C₅-C₂₀ alkyl succinic acids and their salts (2-dodecenyl-succinates, lauryl succinates);
carboxylic polyacetal esters;
polyaspartic acid and polyglutamic acid and their salts;
polyimides derived from the polycondensation of aspartic acid and/or of glutamic acid;
polycarboxymethyl derivatives of glutamic acid or of other amino acids.

### Bleaching Agents

The composition may also comprise at least one oxygen-releasing bleaching agent comprising a percompound, preferably a persalt. Said bleaching agent may be present in an amount corresponding to about 1% to 30% and preferably from 4% to 20% by weight relative to the composition. As examples of percompounds which may be used as bleaching agents, mention should be made in particular of perborates such as sodium perborate monohydrate or tetrahydrate; peroxygenated compounds such as sodium carbonate peroxyhydrate, pyrophosphate peroxyhydrate, urea peroxyhydrate, sodium peroxide and sodium persulfate. The preferred bleaching agents are sodium perborate monohydrate or tetrahydrate and/or sodium carbonate peroxyhydrate. Said agents are generally combined with a bleaching activator which generates, in situ in the washing medium, a peroxycarboxylic acid in an amount corresponding to about 0.1% to 12% and preferably from 0.5% to 8% by weight relative to the composition. Among these activators, mention may be made of tetraacetylethylenediamine, tetraacetyl-methylenediamine, tetraacetylglycoluryl, sodium p-acetoxybenzenesulfonate, pentaacetylglucose and octaacetyllactose. Mention may also be made of non-oxygenated bleaching agents, which act by photoactivation in the presence of oxygen, these being agents such as sulfonated aluminum and/or zinc phthalocyanins.

### Soil-Release Agents

These may be used in amounts of about 0.01-10 wt. %, preferably about 0.1-5 wt. % and more preferably about 0.2-3 wt. %. Mention may be made more particularly of agents including but not limited to:
polyvinyl alcohols;
polyester copolymers based on ethylene terephthalate and/or propylene terephthalate and polyoxyethylene terephthalate units, with an ethylene terephthalate and/or propylene terephthalate (number of units)/polyoxyethylene terephthalate (number of units) molar ratio from about 1/10 to 10/1 and preferably from about 1/1 to 9/1, the polyoxyethylene terephthalates containing polyoxyethylene units with a molecular weight from about 300 to 5,000 and preferably from about 600 to 5,000;
sulfonated polyester oligomers obtained by sulfonation of an oligomer derived from ethoxylated allylic alcohol, from dimethyl terephthalate and from 1,2-propylene diol, containing from 1 to 4 sulfonated groups;
polyester copolymers based on propylene terephthalate and polyoxyethylene terephthalate units and ending with ethyl or methyl units or polyester oligomers ending with alkylpolyethoxy groups or sulfopolyethoxy or sulfoaroyl anionic groups;
sulfonated polyester copolymers derived from terephthalic, isophthalic and sulfoisophthalic acid, anhydride or diester and from a diol.

### Enzymes

The enzyme is preferably selected from the group constituted by: hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. Preferably, the enzymes are proteases, amylases and lipases.

The most commonly used enzymes are proteases (break down protein), amylases (break down starch—a type of carbohydrate) and lipases (break down fats).

Preferred enzymes could include a protease. Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

Suitable proteases include metalloproteases and serine proteases, including neutral or alkaline microbial serine proteases, such as subtilisins (EC 3.4.21.62). In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include but are not limited to:
subtilisins (EC 3.4.21.62), including those derived from Bacillus, such as Bacillus lentus, B. alkalophilus, B. subtilis, B. amyloliquefaciens, Bacillus pumilus and Bacillus gibsonii;
trypsin-type or chymotrypsin-type proteases, such as trypsin (e.g., of porcine or bovine origin), including Fusarium protease and chymotrypsin proteases derived from Cellumonas;
metalloproteases, including those derived from Bacillus amyloliquefaciens;
subtilisin proteases derived from the Bacillus sp TY-145, NCIMB 40339.

### Non-Ionic Polysaccharides

In some embodiments, the composition further comprises a non-ionic polysaccharide. The nonionic polysaccharide can be a modified nonionic polysaccharide. The modified nonionic polysaccharide may comprise hydroxyalkylations. In the context of the present application, the degree of hydroxyalkylation (molar substitution or ms) of the modified nonionic polysaccharides means the number of alkylene oxide molecules consumed by the number of free hydroxyl functions present on the polysaccharides. In one embodiment, the MS of the modified nonionic polysaccharide is in the range of 0 to 3. In another embodiment, the MS of the modified nonionic polysaccharide is in the range of 0.1 to 3. In still another embodiment, the MS of the modified nonionic polysaccharide is in the range of 0.1 to 2.

The nonionic polysaccharide may be selected from modified or non-modified glucans, modified or non-modified starches (such as those derived, for example, from cereals, for instance wheat, corn or rice, from vegetables, for instance yellow pea, and tubers, for instance potato or cassava), amylose, amylopectin, glycogen, dextrans, celluloses and derivatives thereof (methylcelluloses, hydroxyalkylcelluloses, ethylhydroxyethylcelluloses), mannans, xylans, lignins, arabans, galactans, galacturonans, chitin, chitosans, glucuronoxylans, arabinoxylans, xyloglucans, glucomannans, pectic acids and pectins, arabinogalactans, carrageenans, agars, gum arabics, gum tragacanths, ghatti gums, karaya gums, carob gums, modified galactomannans such as modified nonionic derivatives of guars (hydroxypropyl guar), and mixtures thereof.

Among the celluloses that are especially used are hydroxyethylcelluloses and hydroxypropylcelluloses. Mention may be made of the products sold under the names Klucel® EF, Klucel® H, Klucel® LHF, Klucel® MF and Klucel® G by the company Aqualon, and Cellosize® Polymer PCG-10 by the company Amerchol.

In one embodiment, the nonionic polysaccharide is a modified nonionic guar. The modified nonionic guars are especially modified with C₁-C₆ hydroxyalkyl groups. Among the hydroxyalkyl groups that may be mentioned, for example, are hydroxymethyl, hydroxyethyl, hydroxypropyl and hydroxybutyl groups. These guars are well known in the prior art and can be prepared, for example, by reacting the corresponding alkene oxides such as, for example, propylene oxides, with the guar so as to obtain a guar modified with hydroxypropyl groups.

The nonionic polysaccharide, such as the nonionic guar, may have an average Molecular Weight (Mw) of between 100,000 Daltons and 3,500,000 Daltons, preferably between 500,000 Daltons and 3,500,000 Daltons.

The composition may comprise from 0.05 to 10 wt. % of the nonionic polysaccharide based on the total weight of the composition, preferably from 0.05 to 5 wt. % more preferably from 0.2 to 2 wt. %.

### Silicones

The composition may further comprise a silicone compound. The silicone compound of the invention can be a linear or branched structured silicone polymer. The silicone of the present invention can be a single polymer or a mixture of polymers. Suitable silicone compounds include polyalkyl silicone, aminosilicone, siloxane, polydimethyl siloxane, ethoxylated organosilicone, propoxylated organosilicone, ethoxylated/propoxylated organosilicone and mixture thereof. Suitable silicones include but are not limited to those available from Wacker Chemical, such as Wacker® FC 201 and Wacker® FC 205. Preferably the silicone compound is an aminoslilicone.

Should the disclosure of any patents, patent applications, and publications which are incorporated herein by reference conflict with the description of the present application to the extent that it may render a term unclear, the present description shall take precedence.

### EXAMPLES

### Materials:

Natural Polygalactomannan: Natural guar having a Brookfield RVT viscosity 5 at 25° C. and 20 rpm with spindle #4 between 7,350 and 7,400 mPa·s, at a concentration of 1.0 wt % in water, available from Solvay under the name Jaguar® S.
Test fabric treated with the Natural Polygalactomannan containing liquid laundry detergent formulation according to Table 1 (Composition 2): one (1) PT-1 Cotton, jersey, un-pilled, pilling prevention test fabric, 4280-79, purchased from Center For Testmaterials Cft BV.
Test fabric without being treated with the Natural Polygalactomannan, with liquid laundry detergent formulation according to Table 1 (Composition 1): one (1) PT-1 Cotton, jersey, un-pilled, pilling prevention test fabric, 4280-79, purchased from Center For Testmaterials Cft BV.

### Example 1

Wash Protocol with the Natural Polygalactomannan:
The test fabric, PT-1 Cotton, jersey, un-pilled were placed in Samsung front load washing machine (model: WW90H5200EW/SP) with washing program for cotton (washing temperature: 40° C. and washing time: 2 hours 42 min which includes 3 rinses with 1200 RPM spin);
Ballast load is 2.6 kg of cotton bath towels. The ballast load was pre-washed once with 100 mL the liquid detergent used in the test with washing program for cotton (washing temperature: 40° C. and washing time: 2 hours 42 min which includes 3 rinses with 1200 RPM spin);
Liquid detergent with composition according to Table 1 was added in an amount of 100 mL per wash cycle;
the test fabric was washed together with the ballast load for ten (10) wash cycles.
   After each wash cycle, the PT-1 Cotton, jersey, un-pilled were line-dried in a control humidity room at 22° C. with humidity of 62.5%. The ballast load was tumble-dried with ELBA Dual Heat Sensordry EBD 602S for 80 minutes with high heat program.
   Wash Protocol without the Natural Polygalactomannan:
   The wash protocol without the Natural Polygalactomannan was the same as the wash protocol with the Natural Polygalactomannan, as described above, except that the liquid laundry detergent formulation did not contain the Natural Polygalactomannan was added to the wash cycles.

TABLE 1
Liquid Laundry Detergent Compositions

| | | Composition 1 | Composition 2 |
|---|---|---|---|
| Ingredients | Chemistry | (%. wt as active) | (%. wt as active) |
| Rhodacal | Linear alkyl | 2.5 | 2.5 |
| SSA | benzene sulfonic | | |
| | acid | | |
| Rhodasurf | Alcohol ethoxylate | 4.0 | 4.0 |
| L7/90 | (EO7) | | |
| Rhodapex | Sodium lauryl ether | 2.5 | 2.5 |
| ESB70 | sulphate | | |
| Coconut | Fatty acid | 0.8 | 0.8 |
| fatty acid | | | |
| NaOH, 40%. | Base | to pH 8.2 | to pH 8.2 |
| wt solution | | | |
| in water | | | |
| Propylene | Solvent | 5.0 | 5.0 |
| glycol | | | |
| Jaguar ® S | Natural | 0 | 0.5 |
| | Polygalactomannan | | |
| Water | Solvent | to 100% | to 100% |

Test Results—Pilling Degree:

For each of the PT-1 Cotton, jersey, un-pilled, the degree of pilling was determined by visual observation of its photograph taken with Nikon D7200 Digital SLR camera equipment with AF-S Nikkor 18-105 mm lens with a fixed distance, aperture, focal point, shutter speed and controlled lighting.

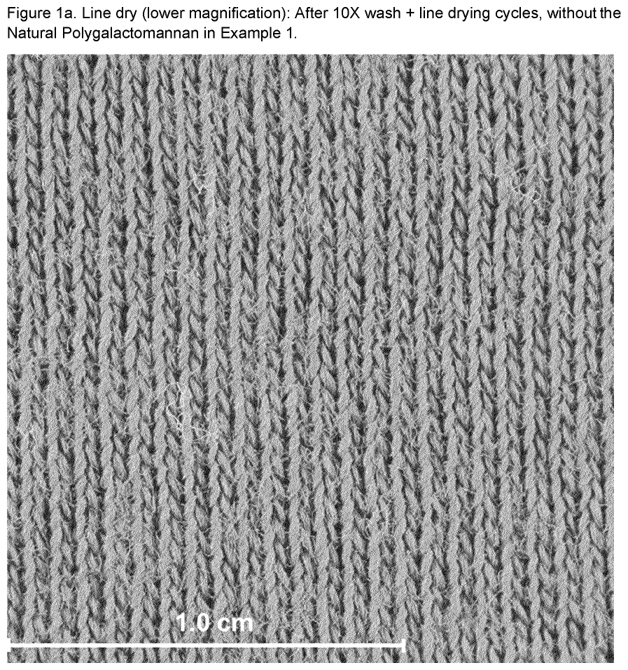

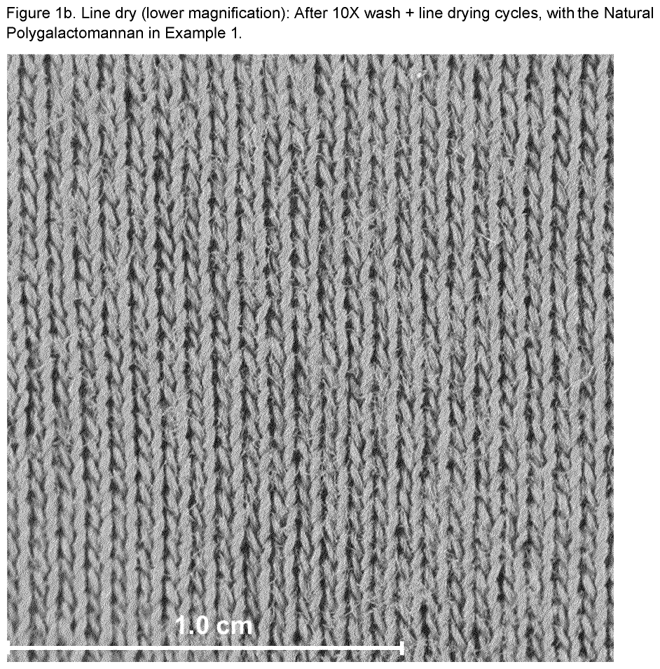

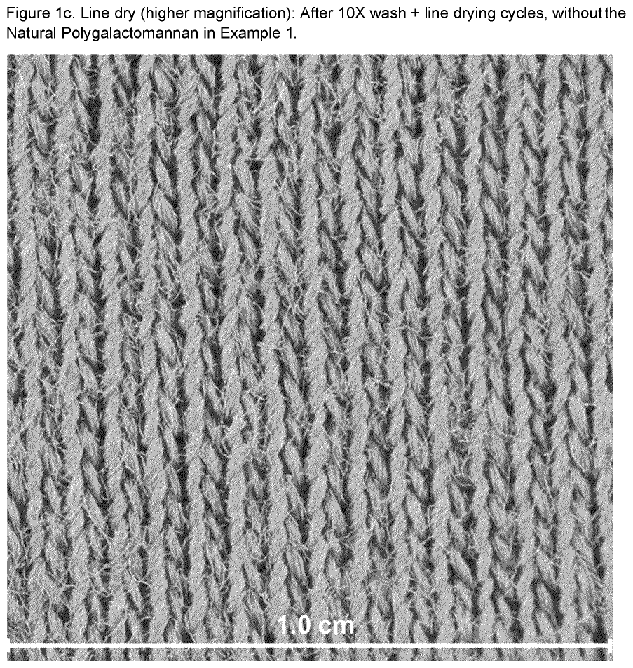

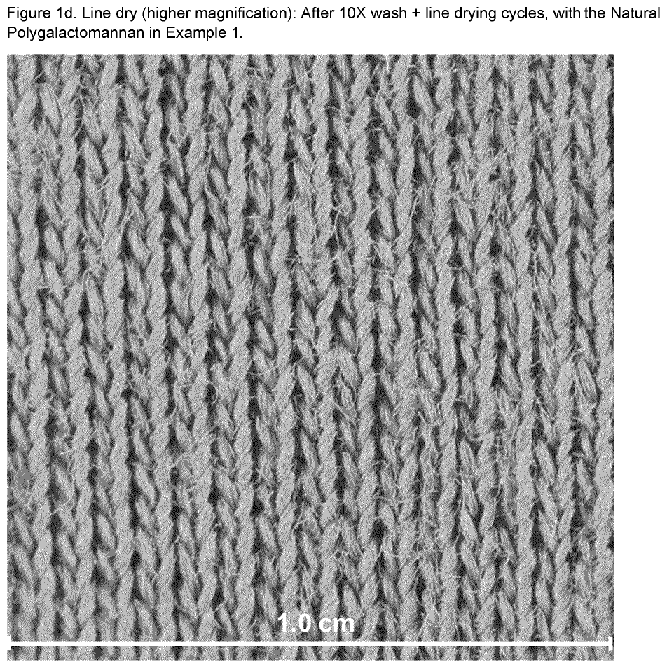

FIG. 1a shows a PT-1 Cotton, jersey, un-pilled under magnification after being washed ten (10) times in accordance with the wash protocol without the Natural Polygalactomannan, in which the test fabric was line dried, and FIG. 1b shows a PT-1 Cotton, jersey, un-pilled under magnification after being washed ten (10) times in accordance with the wash protocol with the Natural Polygalactomannan, in which the test fabric was line dried. FIG. 1b shows that fabrics treated with the Natural Polygalactomannan, which are then line-dried after treatment, have a lower pilling degree than those not treated with the Natural Polygalactomannan (FIG. 1a). This indicates that the Natural Polygalactomannan can provide better fiber protection. FIGS. 1c and 1d, which are under greater magnification, verify the lower pilling degree of the PT-1 Cotton, jersey, un-pilled treated with the Natural Polygalactomannan (FIG. 2d showing lower pilling and better fabric protection) versus not being treated with the Natural Polygalactomannan (FIG. 1c showing greater pilling and lower fabric protection).

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1. A method for treating a fabric, comprising the step of contacting the fabric with a natural polygalactomannan, wherein the natural polygalactomannan has a viscosity of 1,000 to 10,000 mPa·s, as measured on a Brookfield RVT viscosimeter at 25° C. and 20 rpm with a #3 or #4 spindle, at a concentration of 1 wt. % in water.

2. The method according to claim 1, wherein the natural polygalactomannan has a viscosity of 2,000 to 9,000 mPa·s, as measured on a Brookfield RVT viscosimeter at 25° C. and 20 rpm with a #3 or #4 spindle, at a concentration of 1 wt. % in water.

3. The method according to claim 1, wherein the natural polygalactomannan has a viscosity of 3,000 to 8,000 mPa·s, as measured on a Brookfield RVT viscosimeter at 25° C. and 20 rpm with a #3 or #4 spindle, at a concentration of 1 wt. % in water.

4. The method according to claim 1, wherein the natural polygalactomannan is a natural guar.

5. The method according to claim 4, wherein the natural guar is selected from a depolymerized natural guar.

6. The method according to claim 1, wherein the method comprises a step of contacting a fabric having degradation with said natural polygalactomannan.

7. The method according to claim 1, wherein the method is for preventing or recovering degradation of the fabric.

8. The method according to claim 1, wherein the method is for protecting colors of the fabric.

9. (canceled)

10. (canceled)

11. (canceled)

12. A liquid detergent composition, comprising:
(a) from 0.01 to 5 wt. % of a natural polygalactomannan having a viscosity of 1,000 to 10,000 mPa·s, as measured on a Brookfield RVT viscosimeter at 25° C. and 20 rpm with a #3 or #4 spindle, at a concentration of 1 wt. % in water;
(b) from 0.1 to 20 wt % of an anionic surfactant;
(c) from 0.01 to 20 wt % of a non-ionic surfactant or an amphoteric surfactant; and
(d) water;
weight percentages are based on total weight of the composition.

13. The liquid detergent composition according to claim 12, wherein the natural polygalactomannan has a viscosity of 2,000 to 9,000 mPa·s, as measured on a Brookfield RVT viscosimeter at 25° C. and 20 rpm with a #3 or #4 spindle, at a concentration of 1 wt. % in water.

14. The liquid detergent composition according to claim 13, wherein the natural polygalactomannan has a viscosity of 3,000 to 8,000 mPa·s, as measured on a Brookfield RVT viscosimeter at 25° C. and 20 rpm with a #3 or #4 spindle, at a concentration of 1 wt. % in water.
